(19) United States
(12) Patent Application Publication
(10) Pub. No.: US 2013/0325623 A1
(43) Pub. Date: Dec. 5, 2013

(54) METHOD AND APPARATUS FOR REAL ESTATE CORRELATION AND MARKETING

(71) Applicants: Brian Balduf, Algonquin, IL (US); Alex Zoghlin, Lake Forest, IL (US)

(72) Inventors: Brian Balduf, Algonquin, IL (US); Alex Zoghlin, Lake Forest, IL (US)

(73) Assignee: VHT, INC., Rosemont, IL (US)

(21) Appl. No.: 13/482,751

(22) Filed: May 29, 2012

(51) Int. Cl. G06Q 30/06; G06Q 30/02

(52) U.S. Cl. 705/14.66; 705/26.1; 705/14.4

(57) ABSTRACT

Methods and apparatus for matching a real estate listing to a buyer profile and creating a marketing campaign based on the buyer profile are disclosed. The presently disclosed correlation and marketing system processes a plurality of previously executed real estate transactions to create a knowledge database. The knowledge database stores correlations between real estate attributes, buyer attributes, advertiser attributes, and publisher attributes. When a new real estate listing is entered in to the correlation and marketing system, the system uses the knowledge database to determine a buyer profile for that real estate listing. The correlation and marketing system also automatically generates a recommended marketing plan, marketing activities or media buys for that buyer profile based on the associated attributes. The real estate agent may then adjust the marketing plan. Once the marketing plan is accepted, it is automatically executed.

### TECHNICAL FIELD

The present disclosure relates in general to real estate software, and, in particular, to methods and apparatus for correlating real estate attributes, consumer attributes, advertiser attributes, and publisher attributes to create marketing activities.

### BACKGROUND

When new homes or other real estate are offered for sale, the property is typically listed via a real estate agent. As result, the listing agent is contractually entitled to a percentage of the sale of the home. Due to this commission, the real estate agent is motivated to sell the property and often engages in active marketing to sell the property.

However, different types of property attract different types of consumers. Consumers may be sellers or buyers of real estate who consume or use real estate. In addition, different types of consumers encounter and respond to different types of marketing channels and materials. As a result, “one size fits all” marketing is typically ineffective. To counter this problem, real estate agents may employ different types of marketing campaigns for different types of properties in an effort to reach their target buyers.

However, the methods currently used to select a marketing camping suffer from certain drawbacks. More specifically, existing marketing campaign selection mechanisms are based on the limited experience of a small number of people, subjective opinions, and experimentation. As a result, the effectiveness of these campaigns is inconsistent and inefficient.

### SUMMARY

The present disclosure provides new and innovative methods and apparatus for marketing and selling real estate.

In an example embodiment, a method of selling real estate comprises: processing a plurality of real estate transactions including sales of real estate properties to buyers of the real estate properties, the real estate properties having first real estate attributes and the buyers having first buyer attributes; generating correlations between the first real estate attributes and the first buyer attributes; generating a knowledge database storing the processed real estate transactions, the first real estate attributes, and the first buyer attributes; receiving a real estate listing for a target real estate property, the target real estate property having second real estate attributes, the real estate listing including the second real estate attributes; determining an optimized buyer profile based upon the knowledge database and the real estate listing; and generating recommended marketing activities based upon the optimized buyer profile.

### BRIEF DESCRIPTION OF THE DRAWINGS

FIG. 1 is a high level block diagram of an example communications system, according to an example embodiment of the present invention.

FIG. 2 is a more detailed block diagram showing one example of a computing device, according to an example embodiment of the present invention.

FIG. 3 is a flowchart of an example process to match a real estate listing to a consumer profile and create a marketing campaign based on the consumer profile, according to an example embodiment of the present invention.

FIGS. 4A-4B are a list of example real estate attributes, according to an example embodiment of the present invention.

FIG. 5 is an example correlation matrix showing correlation combinations between various attributes, according to an example embodiment of the present invention.

FIGS. 6 to 15 are example screenshots one example embodiment of the present invention.

FIG. 16 is a block diagram showing an example correlation and marketing structure, according to an example embodiment of the present invention.

FIG. 17 is a block diagram showing an example data architecture, according to an example embodiment of the present invention.

### DETAILED DESCRIPTION OF EXEMPLARY EMBODIMENTS

In one embodiment, the disclosed correlation and marketing system collects a very large number of previously executed real estate transactions to create a knowledge database. The knowledge database stores correlations between real estate attributes, consumer attributes, advertiser attributes, and publisher attributes. When a new real estate listing is entered in to the correlation and marketing system, the correlation and marketing system uses the knowledge database to determine a consumer profile for that real estate listing. The correlation and marketing system also automatically generates a recommended marketing plan, marketing activities or media buys for that consumer profile based on the associated attributes. The real estate agent may then adjust the marketing plan (e.g., adjust the budget). Once the marketing plan is accepted, it is automatically executed. At certain times, the knowledge database is updated to improve its accuracy and automatically adjust the marketing plan.

In one embodiment, the correlation and marketing system recommends marketing activities that include marketing tactics, marketing strategies, and search results. For example, the correlation and marketing system may recommend targeted search results based upon an optimized buyer profile.

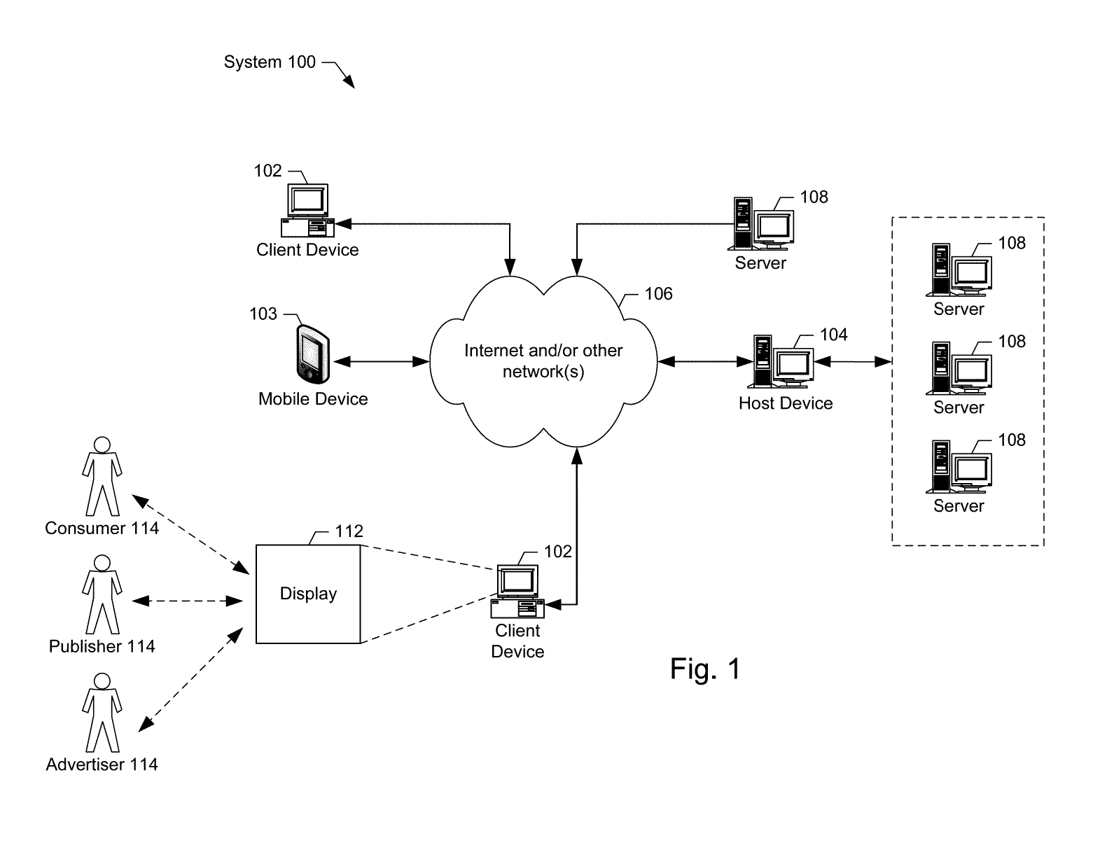

The present system may be readily realized in a network communications system. A high level block diagram of an example network communications system 100 is illustrated in FIG. 1. The illustrated system 100 includes one or more client devices 102, and one or more host devices 104. The system 100 may include a variety of client devices 102, such as desktop computers and the like, which typically include a display 112, which is a user display for providing information to users 114 of the correlation and marketing system, such as consumers, publishers and/or advertisers, described below, and various interface elements as will be discussed in further detail below. A client device 102 may be a mobile device 103, which may be a cellular phone, a personal digital assistant, a laptop computer, a tablet computer, etc. The client devices 102 may communicate with the host device 104 via a connection to one or more communications channels 106 such as the Internet or some other data network, including, but not limited to, any suitable wide area network or local area network. It should be appreciated that any of the devices described herein may be directly connected to each other instead of over a network. Typically, one or more servers 108 may be part of the network communications system 100, and may communicate with host servers 104 and client devices 102.

One host device 104 may interact with a large number of users 114 at a plurality of different client devices 102. Accordingly, each host device 104 is typically a high end computer with a large storage capacity, one or more fast microprocessors, and one or more high speed network connections. Conversely, relative to a typical host device 104, each client device 102 typically includes less storage capacity, a single microprocessor, and a single network connection. It should be appreciated that a user 114 as described herein may include any person or entity which uses the presently disclosed correlation and marketing system and may include a wide variety of parties. For example, as will be discussed in further detail below, users 114 of the presently disclosed correlation and marketing system may include consumers, publishers and/or advertisers.

Typically, host devices 104 and servers 108 store one or more of a plurality of files, programs, databases, and/or web pages in one or more memories for use by the client devices 102, and/or other host devices 104 or servers 108. A host device 104 or server 108 may be configured according to its particular operating system, applications, memory, hardware, etc., and may provide various options for managing the execution of the programs and applications, as well as various administrative tasks. A host device 104 or server may interact via one or more networks with one or more other host devices 104 or servers 108, which may be operated independently. For example, host devices 104 and servers 108 operated by a separate and distinct entities may interact together according to some agreed upon protocol.

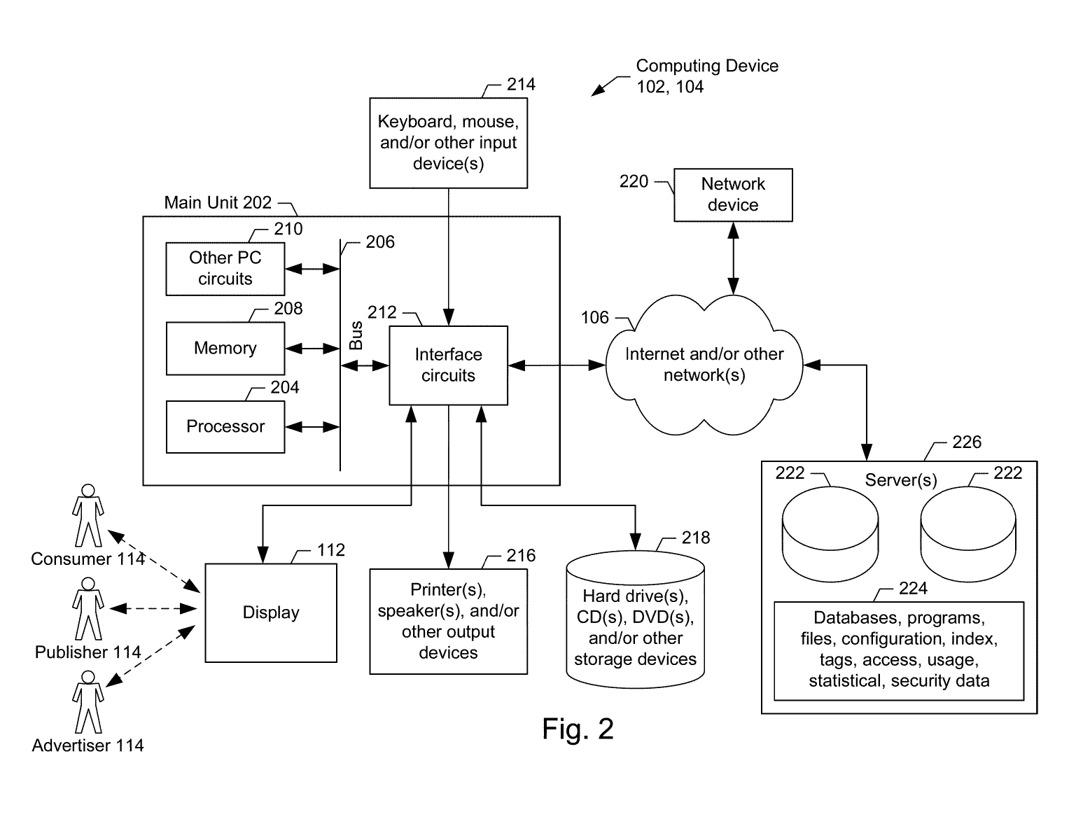

A detailed block diagram of the electrical systems of an example computing device (e.g., a client device 102, and a host device 104) is illustrated in FIG. 2. In this example, the computing device 102, 104 includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with the other devices in the system 100 as described below. This program may be executed by the processor 204 in any suitable manner. In an example embodiment, memory 208 may be part of a “cloud” such that cloud computing may be utilized by a computing devices 102, 104. The memory 208 may also store digital data indicative of documents, files, programs, web pages, etc. retrieved from a computing device 102, 104 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, image sensor, character recognition, barcode scanner, and/or a voice recognition system.

One or more displays 112, printers, speakers, and/or other output devices 216 may also be connected to the main unit 202 via the interface circuit 212. The display 112 may be a cathode ray tube (CRTs), a liquid crystal display (LCD), or any other type of display. The display 112 generates visual displays generated during operation of the computing device 102, 104. For example, the display 112 may provide a user interface, which will be described in further detail below, and may display one or more web pages received from a computing device 102, 104. A user interface may include prompts for human input from a user 114 including links, buttons, tabs, checkboxes, thumbnails, text fields, drop down boxes, etc., and may provide various outputs in response to the user inputs, such as text, still images, videos, audio, and animations.

One or more storage devices 218 may also be connected to the main unit 202 via the interface circuit 212. For example, a hard drive, CD drive, DVD drive, and/or other storage devices may be connected to the main unit 202. The storage devices 218 may store any type of data, such as pricing data, transaction data, operations data, inventory data, commission data, manufacturing data, image data, video data, audio data, tagging data, historical access or usage data, statistical data, security data, etc., which may be used by the computing device 102, 104.

The computing device 102, 104 may also exchange data with other network devices 220 via a connection to the network 106. Network devices 220 may include one or more servers 226, which may be used to store certain types of data, and particularly large volumes of data which may be stored in one or more data repository 222. A server 226 may include any kind of data 224 including databases, programs, files, libraries, pricing data, transaction data, operations data, inventory data, commission data, manufacturing data, configuration data, index or tagging data, historical access or usage data, statistical data, security data, etc. A server 226 may store and operate various applications relating to receiving, transmitting, processing, and storing the large volumes of data. It should be appreciated that various configurations of one or more servers 226 may be used to support and maintain the system 100. For example, servers 226 may be operated by various different entities, including automobile manufacturers, brokerage services, automobile information services, etc. Also, certain data may be stored in a client device 102 which is also stored on the server 226, either temporarily or permanently, for example in memory 208 or storage device 218. The network connection may be any type of network connection, such as an Ethernet connection, digital subscriber line (DSL), telephone line, coaxial cable, wireless connection, etc.

Access to a computing device 102, 104 can be controlled by appropriate security software or security measures. An individual users' 114 access can be defined by the computing device 102, 104 and limited to certain data and/or actions. Accordingly, users 114 of the system 100 may be required to register with one or more computing devices 102, 104. For example, registered users 114 may be able to request or manipulate data, such as submitting requests for pricing information or providing an offer or a bid.

As noted previously, various options for managing data located within the computing device 102, 104 and/or in a server 226 may be implemented. A management system may manage security of data and accomplish various tasks such as facilitating a data backup process. A management system may be implemented in a client 102, a host device 104, and a server 226. The management system may update, store, and back up data locally and/or remotely. A management system may remotely store data using any suitable method of data transmission, such as via the Internet and/or other networks 106.

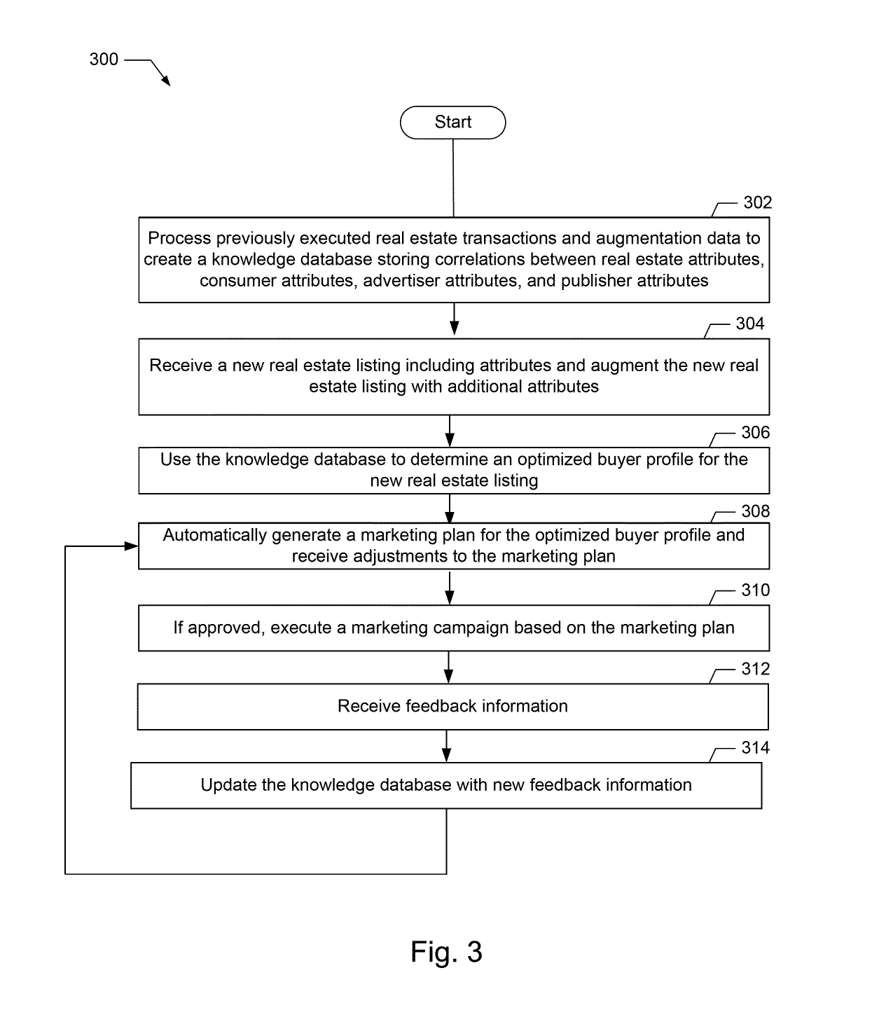

A flowchart of an example process 300 for matching a real estate listing to a consumer profile and creating a marketing campaign based on the consumer profile is illustrated in FIG. 3. Preferably, the process 300 is embodied in one or more software programs which is stored in one or more memories and executed by one or more processors. Although the process 300 is described with reference to the flowchart illustrated in FIG. 3, it will be appreciated that many other methods of performing the acts associated with process 300 may be used. For example, the order of many of the steps may be changed, and many of the steps described are optional.

In general, the process 300 uses a plurality of previously executed real estate transactions to create a knowledge database. The knowledge database stores correlations between real estate attributes, consumer attributes, advertiser attributes, and publisher attributes. When a new real estate listing is entered in to the correlation and marketing system, the correlation and marketing system uses the knowledge database to determine a consumer profile for that real estate listing. The correlation and marketing system also automatically generates a recommended marketing plan for that consumer profile based on the associated attributes. The real estate agent may then adjust the marketing plan. Once the marketing plan is accepted, it is automatically executed. At certain times, the knowledge database is updated to improve its accuracy and automatically adjust the marketing plan.

The process 300 preferably begins by using a very large number of previously executed real estate transactions to create a knowledge database (block 302). The knowledge database stores correlations between real estate attributes, consumer attributes, advertiser attributes, and publisher attributes. For example, hundreds of thousands of previous real estate transactions and related data are preferably used to find relevant and significant correlations between each of these attributes. In addition, the real estate transaction data is preferably augmented with additional attributes from other data sources. For example, data associated with a particular buyer's interest may be gathered from a social networking website.

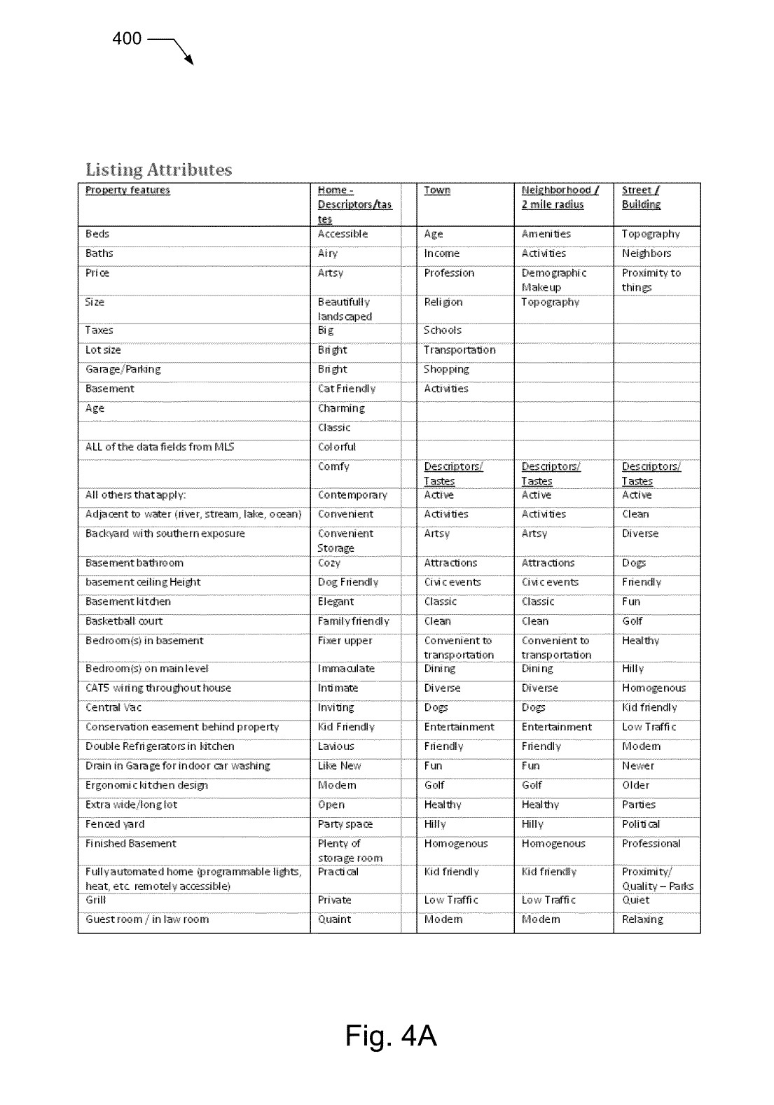

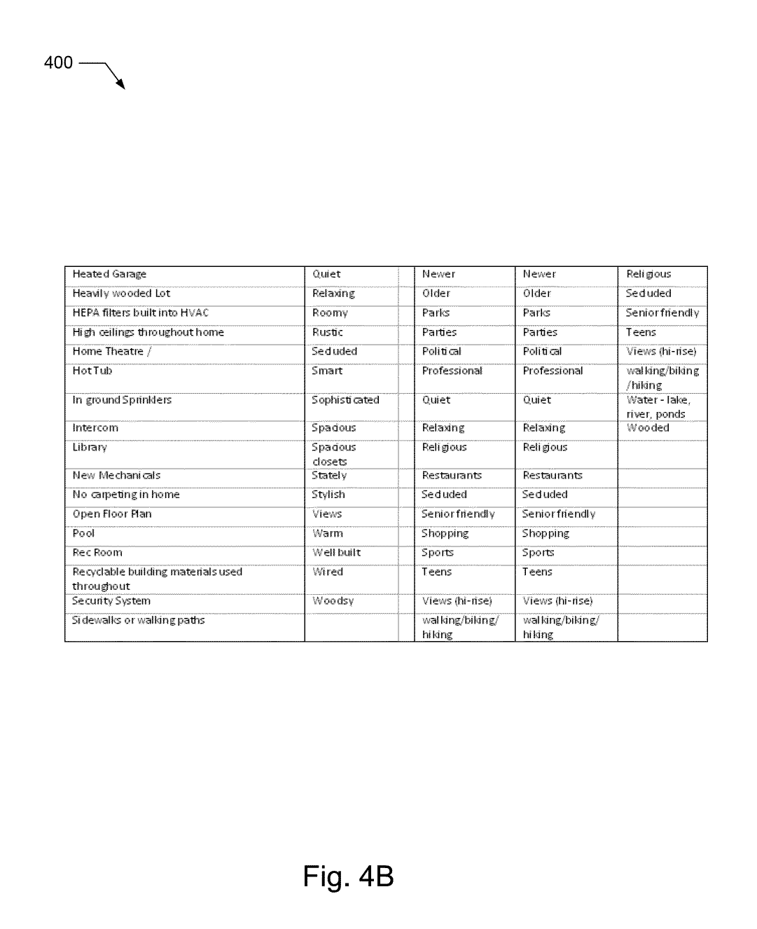

Real estate (i.e., listing) attributes may include a number of bedrooms, a number of bathrooms, a price, a home size, a tax amount, a lot size, a parking size, a basement indicator, an age, and/or any other suitable real estate attributes. Additional examples of real estate attributes are shown in FIG. 4A and FIG. 4B.

Consumer attributes may include age, gender, family size, pets, hobbies, preferences, and/or any other suitable consumer attributes. Additional examples of consumer attributes are shown in Table 1.

TABLE 1
Consumer Attributes

Demographic

AGE
Gender
Sexual orientation
Profession
Ethnicity
Marital Status
Family size
Family lifecycle
Generation (baby-boomers, Gen X, etc . . .)
Income
Occupation
Education
Nationality
Religion
Social Class
Political Affiliation

Psychographic

Hobbies
Level Technical savvy
Activities
Interests
Opinions
Attitudes
Values
Lifestyle traits
Health consciousness

Behavioralistic Attributes

Decision making style
Communication preference &/or style
Benefits Sought
Usage Rate
Brand Loyalty
User Status (potential, first-time, regular user, searcher,
discriminator, etc . . .)
Readiness to buy
Occasions (Holidays and Events that stimulate an action or
response)
Preferred listing attributes

always looks at pools,
prefers cul-de-sac
likes wooded area
Large backyard, etc . . .

Preferred advertisers (advertisers consumer responded to)
Click stream history
Time of day segmentation (late night user, lunch break user,
etc . . .)

Life Events
Religion
Kids
Neighbors
Pets
Schools
Geography

Current Address
Target address or neighborhood
Neighborhood similar to my own
Rural vs. Urban
Climate
Population size/density
Region
New vs. old

Social Graph

Who they shared listings with
Who they “follow” listings of
Extracted data from social networks

Proximity

Want to live within 10 minutes from office
Want to live at least 10 minutes from parents
Close to public transportation
Need a coffee shop nearby

Advertiser attributes may include geography, products, services, advertising budget, sales cycle, market share, and/or any other suitable advertiser attributes. Additional examples of advertiser attributes are shown in Table 2.

TABLE 2

Advertiser Attributes

Geography
Products
Services
Demographics of customers
Psychographics of customers
Average order size
Income/Revenue of Advertiser
Primary advertising methods
Ad budget
Seasonality of product/service
Industry
Financial health of advertiser
Company structure
Sales cycle
Sales channels/distribution model
Market Share
Customer acquisition cost
Financial metrics
Brand strength
Mission statement
Prior executed campaign

Medium
Cost
success/failure
target market/segmentation

Customer feedback

Publisher attributes may include geography, media type, products, services, circulation, industry, and/or any other suitable publisher attributes. Additional examples of publisher attributes are shown in Table 3.

TABLE 3
Publisher Attributes

Geography
Media

Online
Print
TV
Radio
Signage
Out of Home
Digital Signage Networks (malls, elevators, Wal-Mart TV, etc.)

Products

Magazine ads
Online banner advertising
Online content sponsorship
TV commercials
Radio spots
Newspaper ads
Product placement
Direct marketing
Classified advertising
Sponsorships
Trade show marketing
Social media campaign
email marketing
SMS marketing
Signage
Ad Inventory sizes (full page, 30 seconds, screen takeover, etc.)

Services

Market segmentation
Creative services
Media budget/buying
Tracking of campaign effectiveness
Printing

Demographics of audience
Psychographics of audience
Circulation
Reach
Frequency
Average Insertion Order ($) size
Revenue Model of Publisher (free, subscription, etc.)
Seasonality of product/service
Industry
Financial health of publisher
Company structure
Sales cycle (lead time, special events, frequency of publication, etc.)
Sales channels (online ad purchase, fax order in, sales rep, etc.)
Distribution model (free, delivery, online, over the air, etc.)
Market Share
Customer acquisition cost
Financial metrics
Brand strength
Mission statement
Prior executed campaign

Medium
Cost
success/failure
target market/segmentation

Customer feedback

In one embodiment, the knowledge database stores correlations between any combinations of the real estate attributes, consumer attributes, advertiser attributes, and publisher attributes. The knowledge database and correlations can be used to provide meaningful information about real estate listings in new and previously unexplored contexts. For example, based upon the knowledge database, a home with a dog run (a real estate attribute) may be advertised in a magazine about dogs (a publisher attribute). In another example, a family with three children (a consumer attribute) may be found to be highly correlated to homes with back yards (a real estate attribute).

In one embodiment, the correlation and marketing system generates a correlation matrix that can identify levels of correlations among a wide variety of attributes. Using the correlation matrix, for example, a seller may be able to identify new correlations and exploit these correlations to sell more merchandise. Or, for example, a publisher may advertise in a magazine based upon correlation data provided by the correlation and marketing system. Or, for example, an advertiser may target new potential consumers via a particular magazine or via a particular television show based upon newly-identified correlations.

In one embodiment, the correlation matrix can be used to not only identify correlations between attributes, but also to compare correlations with each other. For example, a magazine about dogs may use the correlation matrix to identify and rank correlations about not only dog runs, but nearby parks, neighbors, nearby restaurants, schools, and shops.

In one embodiment, the correlation and marketing system uses prediction or estimation. In one embodiment, the correlation and marketing system may estimate the interest that a particular home buyer may have in a particular property. The correlation and marketing system may this estimation to determine correlations. Or, the correlation and marketing system may use correlation information from other sources to perform this estimation. Or, the correlation and marketing system may use the estimate to determine how to advertise a certain property to a certain user. The correlation and marketing system may use a weighted scores model to estimate the interest.

Or, the correlation and marketing system may use regression models to predict the behavior of various users. The regression models may be user-centric, where the sample is all listings viewed by a specific user, or listing-centric, where the sample is all users that viewed a specific listing.

In one embodiment, the correlation and marketing system may increase predictive accuracy by blending multiple predictors. In one embodiment, the correlation and marketing system approaches blending as a linear regression problem. The solution in this type of correlation and marketing system are the coefficients, or the weights, that should be given to each of the predictors in the ensemble.

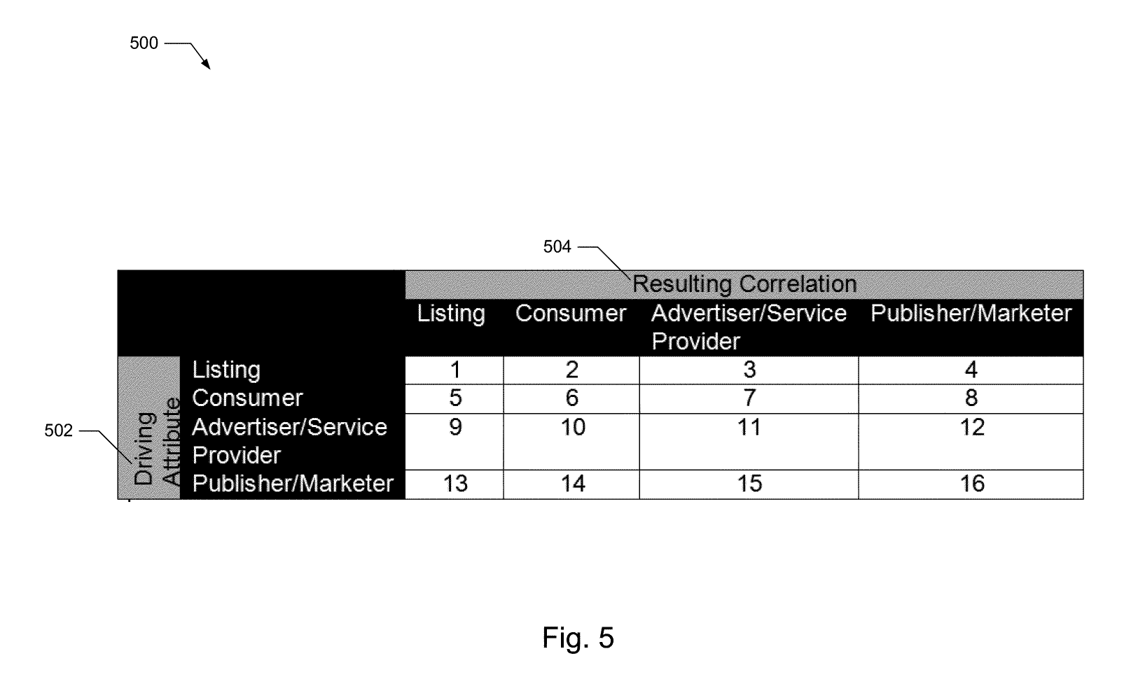

An example correlation matrix 500 showing sixteen correlation combinations is illustrated in FIG. 5. The example correlation matrix organizes driving attributes 502 and resulting correlations 504. For example, the correlation matrix charts real estate attributes, consumer attributes, advertiser attributes, and publisher attributes against each other and places a correlation value that indicates the correlation between various attributes. In one embodiment, the correlation and marketing system receives information about the driving attributes 502 listed vertically in matrix 500 and creates an “ideal” or optimized profile for a correlated listing, consumer, advertiser or marketer. Additional examples of correlations are shown in Tables 4 to 23.

Table 4 provides example data for an example Listing/Listing correlation.

TABLE 4
Listing/Listing

| | |
|---|---|
| a. | Similar Search - For consumers (buyers/sellers), agents, |

advertisers who are searching real estate, find similar
listings which correlate highly with property attributes,
including, but not limited to:

| i. | Same Neighborhood (Lincoln Park, Chicago, IL), |
|---|---|
| | town (Chicago), geography (north side) |
| ii. | Similar Neighborhood (Lincoln Park, Chicago, IL), |
| | town (Chicago), geography (north side) in other |
| | market (San Francisco) |
| iii. | Geography |
| iv. | Price |
| v. | Demographics of census tract |
| vi. | Lot size |
| vii. | Unique listing features (pool, tennis court, |
| | etc.) |
| viii. | Square Footage |
| ix. | Style of home |
| x. | Proximity to desirable neighborhood features |

(train station, coffee shop, parks, etc.)

| | |
|---|---|
| b. | Competitive Market Analysis - use active and sold listing |

pricing to inform a decision on what price to set a new
listing based on correlating similar non-price attributes
(lot size, number of beds/baths, etc.)

Table 5 provides example data for an example Listing/Consumer correlation.

TABLE 5
Listing/Consumer

| c. | Find a Buyer: For an agent or seller, define and/or find |
|---|---|
| | active buyers who would be interested in my listing to |
| | help target marketing of home. (Homes finding buyers) |
| d. | Social Network Pairing: For a buyer, find other active |
| | buyers looking at other homes with attributes I've |
| | either 1) expressed an interest in via actual listings; |
| | 2) provided indications of desired attributes; or 3) |
| | attributes assigned by the correlation and marketing |
| | system based on correlations to known buyer information. |
| e. | Price matching - find buyers with financial constraints |

withing the price point of the listing

For example, a home may have a dog run and be near a golf course. The correlation and marketing system may use this information to build a prototypical buyer based on these home attributes. This information will later inform the suggested marketing campaign and/or description used to market the listing. Or, based on homes a buyer looked at, a buyer may want to discover other prospective buyers to understand the competition, learn about other homes, or connect.

Table 6 provides example data for an example Listing/Advertiser correlation.

TABLE 6
Listing/Advertiser

| | |
|---|---|
| f. | Smart Matching Correlate attributes of a home and/or listing |

to products and services of advertisers.

For example, if a listing has no or poor photographs with the listing, a photography company would target that seller/agent to use its services to promote the home's sale. Or, if a home built twenty years ago may need a new hot water heater, an advertiser may only want to target likely purchasers of hot water heaters. Or, a high end appliance manufacturer may only want to target display advertising on homes listed at over 1 million dollars. Or, hyper local advertisers may only want to target listings in a specific geography.

Table 7 provides example data for an example Listing/Publisher correlation.

TABLE 7
Listing/Publisher

| | |
|---|---|
| g. | House Finding a Buyer Attributes of a home correlate highly |

to the attributes of a publisher's publications' audiences

For example, a house with a dog run may be advertised in Dog Fancy magazine, which attracts dog lovers. Or, home attributes may vary the description used with a given publisher.

Table 8 provides example data for an example Consumer/Listing correlation.

TABLE 8
Consumer/Listing

| | |
|---|---|
| h. | Life Events |

| | |
|---|---|
| i. | Children. |
| ii. | Marriage. |

| | |
|---|---|
| i. | Psychographic Information |
| j. | Demographic Information |

| | |
|---|---|
| i. | A consumer's demographic information (age, marital |

status, family size, income, education level, etc.)
will drive correlations to certain property
attributes (size, single story/multi level,
neighborhood, etc.)

| | |
|---|---|
| k. | Online Behavior |

| | |
|---|---|
| i. | Use a buyer's online behavior to better correlate |

to attributes of a home.

| l. | Self Reporting - consumer attributes are learned from |
|---|---|
| | information they provide via a variety of tools, including |
| | widgets, surveys, games and direct questionnaires. |
| m. | Affordability - A consumer's financial condition that |

drive correlations to certain property attributes (price,
location, amenities, etc . . .)

In one embodiment, the correlation and marketing system may use attributes to create correlations that are useful in buying or selling homes. For example, a family with three children may be highly correlated to homes with backyards. A newly married couple may correlate to smaller homes or condos in a more urban setting. The correlation and marketing system may also use psychographic information. For example, the correlation and marketing system may contain information that a buyer is a biking enthusiast, learned from a variety of sources, including Google searches, social networks, magazine subscriptions, online purchases, or self reporting, which correlates highly with properties near forest preserves, parks, bike paths.

For example, if a buyer looks at homes in Lake Forest, the correlation and marketing system may become better informed about what other properties will be of interest. Or, if a buyer searches boating or fishing websites, the correlation and marketing system may provide a high correlation of that buyer to homes on waterways.

Table 9 provides example data for an example Consumer/Consumer correlation.

TABLE 9
Consumer/Consumer

| n. | Buyers finding Sellers - use common attributes to find |
|---|---|
| | sellers who may have homes you like |
| o. | Buyers finding Buyers - For a buyer, find other active |
| | buyers looking at other homes with attributes that buyer |
| | has either 1) expressed an interest in via actual |
| | listings; 2) provided indications of desired attributes; |
| | or 3) attributes assigned by the correlation and marketing |
| | system based on correlations to known buyer information. |
| p. | Socializing the sales/purchase process |
| q. | Peer Metrics about other participants with similar |

attributes to me

| i. | How many homes are viewed? |
|---|---|
| ii. | How long is the average process? |
| iii. | Average mortgage rate? |
| iv. | Average purchase price? |
| v. | Average listing price to actual sales price |
| | achieved? |
| vi. | What are the most active months for searching, |

viewing and closing purchases?

For example, based on homes a buyer looked at, the buyer wants to discover other prospective buyers to understand the competition, learn about other homes, or connect. Or, users may comment on various vendors or experiences to help others make decisions or avoid pitfalls.

Table 10 provides example data for an example Consumer/Advertiser correlation.

TABLE 10
Consumer/Advertiser

| r. | Smart Matching Correlate attributes of a consumer to |
|---|---|
| | products and services of advertisers |
| s. | Life Events |

| | |
|---|---|
| i. | Children. |
| ii. | Marriage. |

| | |
|---|---|
| t. | Psychographic Information |
| u. | Demographic Information |

| | |
|---|---|
| i. | A consumer's demographic information (age, marital |

status, family size, income, education level, etc.)
will drive correlations to certain products and
services advertisers

| | |
|---|---|
| v. | Online Behavior |

| | |
|---|---|
| i. | Use a buyer's online behavior to better correlate |

to attributes of an advertiser.

| | |
|---|---|
| w. | Self Reporting - consumer attributes are learned by |

information they provide via a variety of tools, including
widgets, surveys, games and direct questionnaires which
can inform advertiser targeting.

For example, a high end appliance manufacturer may only to target display advertising to consumers searching for homes listed at over 1 million dollars. Based on campaign results, a high end appliance manufacturer may only want to target display advertising to consumers over 35 years old and searching for homes listed at over 1 million dollars. Or, a high end appliance manufacturer may only want to target display advertising to consumers who have previously viewed or saved refrigerator-related content. Or, hyper local advertisers may only want to target listings in a specific geography.

Alternatively, a family with three children may be highly correlated to advertisers targeting consumers of children/infant products. Or, a newly married couple will correlate to advertisers of financial services, home goods, appliances, and vacation planning. Or, for example, the correlation and marketing system may contain information that a buyer is a biking enthusiast, learned from a variety of sources, including Google searches, social networks, magazine subscriptions, online purchases, or self reporting, which correlates highly with advertisers of sporting goods, bike shops, or adventure travel.

Or, the correlation and marketing system may recognize that new families are of interest to certain sellers of baby products. Or, older consumers selling their home may be of interest to advertisers targeting retirement living.

For example, a buyer looks at homes in Lake Forest, which correlates highly with advertisers who operate businesses in Lake Forest. Or, a buyer searches boating or fishing websites, which would correlate higher to advertisers of boats, boating equipment, water-based vacation travel, etc. The frequency and timing in which a buyer looks at listings within a period of time may correlate to their position in the buyer lifecycle, which becomes an attribute against which advertisers can target. The correlation and marketing system may identify consumers that looked at homes with pools, add that as an attribute of the consumer, and provide opportunities for advertisers to market specifically to those consumers that looked at pools.

Or, for example, a consumer indicates via viewed photographs that they are interested in high end kitchens. Advertisers of such goods and services would want to target this consumer based on these attributes.

Table 11 provides example data for an example Consumer/Publisher correlation.

TABLE 11
Consumer/Publisher

| x. | Consumer attributes will drive with which Publishers the |
|---|---|
| | correlation and marketing system partners for implementing |
| | an automated marketing plan |
| y. | Consumer attributes will drive with which Publishers |

services are advertised

For example, consumers who commute more than 30 minutes to work from home would lead to billboard advertising. Based on campaign results, the correlation and marketing system may add consumers who have a newer model car and commute at least 30 minutes to work.

Table 12 provides example data for an example Advertiser/Listing correlation.

TABLE 12

Advertiser/Listing

| | |
|---|---|
| z. | Match attributes of advertiser audience/product/service |

to correlated attributes of the listing.

For example, a financial services advertiser may want to advertise alongside high cost listings. Home Improvement advertisers seek properties older than 10 years. Based on campaign results, Home Improvement advertisers may seek properties older than 15 years but not older than 20 years. Or, orthopedic surgeons may target homes with marble floors, staircases, pool decks, etc.

Table 13 provides example data for an example Advertiser/Consumer correlation.

TABLE 13
Advertiser/Consumer

| | |
|---|---|
| aa. | Match attributes of advertiser audience/product/service to |

correlated attributes of the consumer.

For example, Starbucks may target phone users searching homes near their stores. Or, KinderCare targets consumers with young children. The correlation and marketing system may provide for customer segmentation. For example, the correlation and marketing system may suggest diaper discounts to young families and high end goods to high income families.

For example, a local tennis club targets consumers who have a high health conscience cohort and are looking at homes in their market. Or, long distance movers target consumers moving over 200 miles. Or, a lawn care provider who closed 60% of leads sent by correlation and marketing system targeting homeowners with lawns greater than ⅛ acre may create a new campaign targeting homeowners with lawns greater than ¼ acre.

Table 14 provides example data for an example Advertiser/Advertiser correlation.

TABLE 14
Advertiser/Advertiser

| bb. | Advertisers want to advertise alongside their competitors |
|---|---|
| | ( ) |
| cc. | Advertisers want to advertise alongside advertisers of |
| | complementary goods/services. |
| dd. | An advertiser of window treatments wants to target |

consumers who responded favorably to a campaign by an
advertiser of new window.

For example, Visa may want to advertise everywhere MasterCard advertises. Or, Chuck E Cheese advertises near KinderCare.

Table 15 provides example data for an example Advertiser/Publisher correlation.

TABLE 15
Advertiser/Publisher

| | |
|---|---|
| ee. | Match attributes of advertiser audience/product/service to |

correlated attributes of the Publisher.

| i. | Promote listings (advertisements) in publications |
|---|---|
| | read by agents or home buyers |
| ii. | Based on data from the correlation and marketing |

system, a pool service company would want to
advertise in media with prior success in reaching
pool owners.

Table 16 provides example data for an example Publisher/Listing correlation.

TABLE 16
Publisher/Listing

| | |
|---|---|
| ff. | The publisher's ability to accept certain data/media will |

dictate what listing data is sent to the publisher.

For example, YouTube only accepts video and limited text data, so no pictures can be sent or suggested in a system-generated marketing campaign.

Table 17 provides example data for an example Publisher/Consumer correlation.

TABLE 17

Publisher/Consumer

| gg. | A publisher's content will attract a certain segment of |
|---|---|
| | consumers attracted to that subject matter. |
| hh. | Based on the results of an ad campaign with a given |

publisher, the correlation and marketing system iterates
its advertising copy to better target the publisher's
audience.

For example, a listing is advertised as targeting dog owners in the classified section of the Chicago Tribune, and based on the consumers who responded, the listing copy is modified to better highlight the large backyard and nearby Dog Park.

Table 18 provides example data for an example Publisher/Advertiser correlation.

TABLE 18
Publisher/Advertiser

| | |
|---|---|
| ii. | Correlation and marketing system results from prior |

campaigns become attributes that an advertiser would find
value in when designing their ad campaigns.

| | |
|---|---|
| i. | Correlation and marketing system indicates that the |

responding audience for X magazine has a definitive
set of attributes which would attract an advertiser.

Table 19 provides example data for an example Publisher/Publisher correlation.

TABLE 19
Publisher/Publisher

| | |
|---|---|
| jj. | Correlation and marketing system results from prior |

campaigns with competitive publishers become attributes
that a publisher would find value in when targeting
advertisers or other publishers to join together in a
campaign.

For example, a prior ad campaigns in Time magazine results in successful campaigns for financial service companies. Newsweek would want that information to target new advertisers since their audience is similar.

Or, for example, prior marketing campaigns have a high correlation of success when both ads in the Chicago Tribune and signage are used together, which would inform later proposed campaigns generated by the correlation and marketing system.

Or for example, based on prior campaigns in Time magazine, quarter page ads were found to be the most effective. Newsweek would want that information to better sell similar products.

Table 20 provides example data for an example Listing/Consumer/Publisher correlation.

TABLE 20

Listing/Consumer/Publisher

| | |
|---|---|
| kk. | The attributes of a listing highly correlate with certain |

attributes of a buyer. That buyer attributes correlate
highly with the attributes of a publisher's audience.

For example, a home on a golf course is listed for sale. Such homes attract buyers who have a high household income, enjoy outdoor activities, and have at least two children. Golf Digest's audience comprises readers with similar attributes, so Golf Digest is included as a possible publisher of advertisements for this listing. Based on the results of the Golf Digest ad campaign, the correlation and marketing system identifies a finished basement as another listing attribute highly desired by these consumers. Based on these learnings, the correlation and marketing system iterates its marketing campaign to add banner ads in HGTV.com's remodeling section, which is a publisher attracting this segment of consumer.

Or, based on the results of the Golf Digest ad campaign, the correlation and marketing system identifies additional consumer attributes of Golf Digest readers, which include interest in exotic travel. Based on these learnings, the correlation and marketing system iterates its marketing campaign to add travel content sites as possible publishers.

Or, for example, a property is listed with partial information, including only a single photo. Three weeks later, additional data and photography are added, and a different set of consumers attracted to the listing is revealed, and their attributes are the basis for creating or modifying the publishers suggested in the marketing campaign.

Or, for example, a one bedroom condo in a downtown converted loft is listed. Such homes attract single, professional young adults. Such consumers are active smart phone users. Advertising this listing on mobile ad networks on real estate related mobiles sites would be suggested in a marketing campaign for this listing.

Table 21 provides example data for an example Listing/Consumer/Advertiser correlation.

TABLE 21

Listing/Consumer/Advertiser

| | |
|---|---|
| ll. | The attributes of a listing highly correlate with certain |

attributes of a buyer. Those buyer attributes correlate
highly with the attributes of an advertiser.

For example, a home with an outdoor pool is listed for sale. Such homes attract buyers who have a high household income and enjoy outdoor activities. Frontgate, a high end home goods catalog, targets customers that like outdoor activities, and homeowners with outdoor pools. Based on the results of the Frontgate ad campaign, the correlation and marketing system identifies the finished basement as another listing attribute highly desired by these consumers. Based on these learnings, the advertiser now advertises alongside listings with finished basements.

Or, for example, based on the results of the Frontgate ad campaign, the correlation and marketing system identifies an additional attribute of consumers who respond to Frontgate's ads. That attribute is a family size of at least two children. Based on these learnings, the ad system will serve Frontgate ads to consumers with this additional attribute.

Or, for example, a property is listed with partial information, including only a single photo. Three weeks later, additional data and photography are added, and a different set of consumers attracted to the listing is revealed, and their attributes are the basis for attracting different advertisers.

Table 22 provides example data for an example Consumer/Listing/Advertiser correlation.

TABLE 22
Consumer/Listing/Advertiser

| | |
|---|---|
| mm. | The attributes of a consumer highly correlate with certain |

attributes of a listing. Those listing attributes
correlate highly with the attributes of an advertiser.

For example, buyers who have a high household income and enjoy outdoor activities have a high correlation with homes listed for sale with an outdoor pool. Frontgate, a high end home goods catalog, targets advertising on home listings with pools when a consumer that likes outdoor activities is looking at it. Based on the results of the Frontgate ad campaign, the correlation and marketing system identifies an additional attribute of consumers who respond to Frontgate's ads when shown on listings with pools to consumers that enjoy outdoor activities. That attribute is a family size of at least two children. Based on these learnings, the ad system will serve Frontgate ads on listings with pools when consumers who enjoy outdoor activity and have a family size of at least two children view the listing.

Or, for example, based on the results of the Frontgate ad campaign, the correlation and marketing system identifies the finished basement as another listing attribute highly desired by these consumers. Based on these learnings, the advertiser now advertises alongside listings with finished basements.

Or, for example, a consumer with no known income starts using the correlation and marketing system. Three weeks later, additional behavior, correlations, or data is provided to discern the income of the consumer. A different set of listings, advertisers, or both are correlated to the new data. As a result, more targeted advertising is achievable.

Table 23 provides example data for an example Consumer/Listing/Publisher correlation.

TABLE 23

Consumer/Listing/Publisher

| | |
|---|---|
| nn. | Based upon the attributes of consumers looking at a |

particular listing, a publisher can be selected with an
audience that matches the attributes of the consumers
looking at the listing.

For example, a bachelor is searching homes for sale. The correlation and marketing system correlates the attributes of the bachelor and the types of homes he is looking at. Based upon these correlations, the system takes the bachelors correlated attributes and finds a publisher with an audience with the same attributes.

Or, for example, a group of bachelors have been searching homes for sale. The system correlates the attributes of the bachelors and the types of homes they are looking at. Based upon these correlations, the system takes the bachelors' correlated attributes and finds a publisher with an audience with the same attributes.

Referring back to FIG. 3, the attributes of new real estate listings may be entered in to the correlation and marketing system (block 304). For example, a real estate agent may enter a new real estate listing in to a web based system. Next, the real estate agent may augment the listing with additional attributes. The real estate attributes from the listing and/or the augmentation data may include a number of bedrooms, a number of bathrooms, a price, a home size, a home descriptor (e.g., charming), and/or any other suitable real estate attributes (see FIGS. 4A-4B).

In one embodiment, the correlation and marketing system then uses the knowledge database to determine an optimized buyer profile for the new real estate listing that is entered in to the system (block 306). For example, the buyer profile may include consumer attributes such as family size, credit score, pet indicator, and/or any other suitable consumer attributes (see Table 1).

In one embodiment, the correlation and marketing system then automatically generates a marketing plan for that buyer profile (block 308). Preferably, the marketing plan includes suggested advertisements (including media and/or a message) and suggested publishers that are selected based on the buyer profile. The real estate agent may then adjust the marketing plan and decide to approve or reject the marketing plan.

Once approved, the correlation and marketing system executes the marketing campaign based on the generated marketing plan (block 310). For example, the marketing plan preferably includes placing an advertisement with a publisher, wherein the advertisement and/or the publisher are selected based on the associated correlations.

At certain times, the knowledge database is updated to improve its accuracy and automatically adjust the marketing plan (block 312). For example, a number of clicks on an advertisement may cause the marketing plan to be automatically adjusted. This causes the knowledge database to be updated to improve its accuracy (block 314).

Or, the knowledge database may be updated after a property is sold. For example, if a real estate property is sold to a buyer, the buyer's profile may be used and integrated into the knowledge database. In one embodiment, the correlation and marketing system can create better correlations—and thus provide better results—as more buyer attributes and real estate attributes are added to the knowledge database. In one embodiment, each successful real estate transaction can be used as a data point to enhance the accuracy and reliability of the correlation and marketing system. In one embodiment, real estate transactions that fail—e.g., a sale is almost finalized but is then canceled when the prospective buyer decides to move into a home closer to a body of water—may also be used to update and modify the knowledge database.

It should be appreciated that after the correlation and marketing system determines an optimized buyer profile, the correlation and marketing system can search the knowledge database or other data sources for a buyer that matches the optimized buyer profile. In one embodiment, the correlation and marketing system allows a user to specify the match level in returning prospective buyers. For example, a user may specify that he would like a list of prospective buyers that are a 50% match of the optimized buyer profile. Or the user may be able to specify that the correlation and marketing system returns only those prospective buyers that have attributes that match 90% or more of the optimized buyer profile.

Once the knowledge database is updated, the correlation and marketing system may iterate through a new or adjusted marketing plan (block 308). Many iterations, taking in to account many different correlations between real estate attributes, consumer attributes, advertiser attributes, and publisher attributes, may occur.

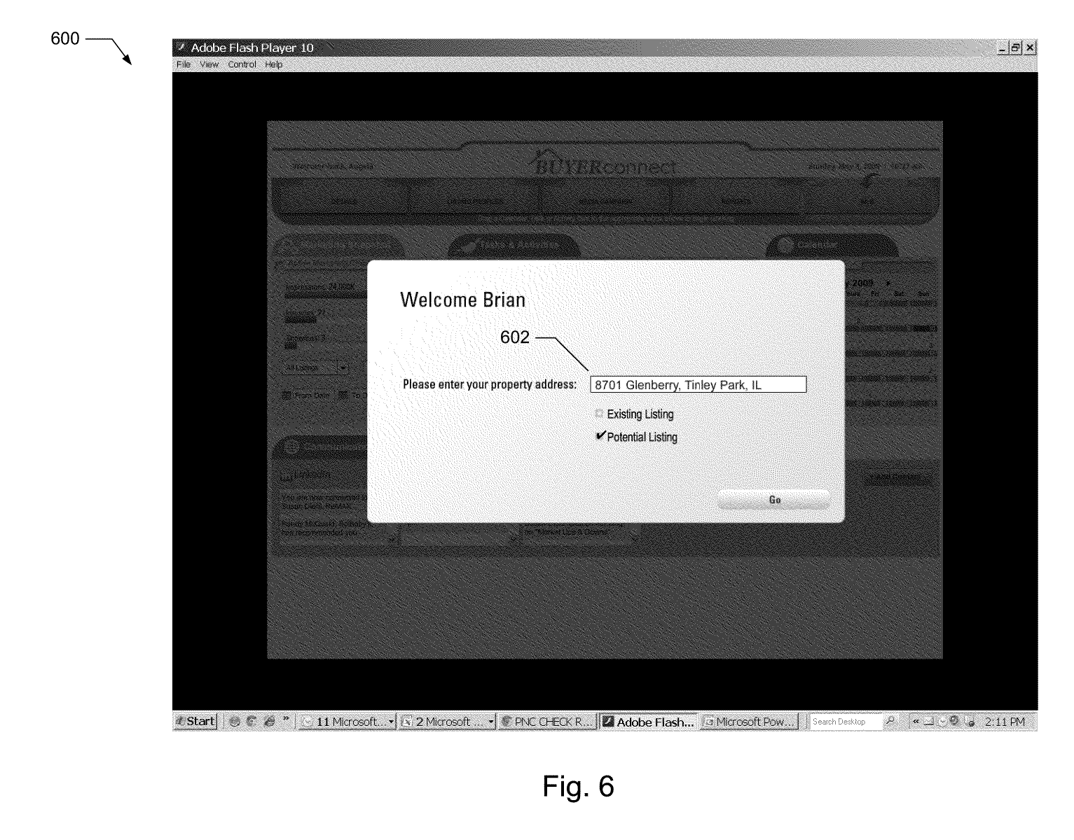

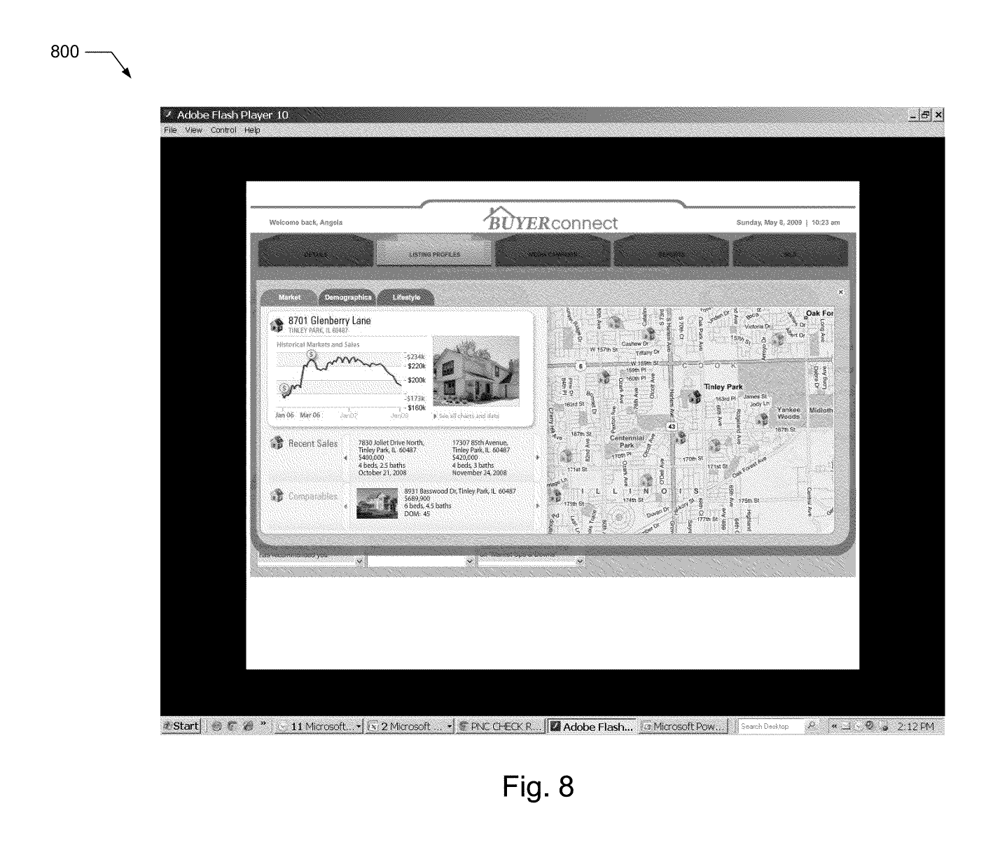

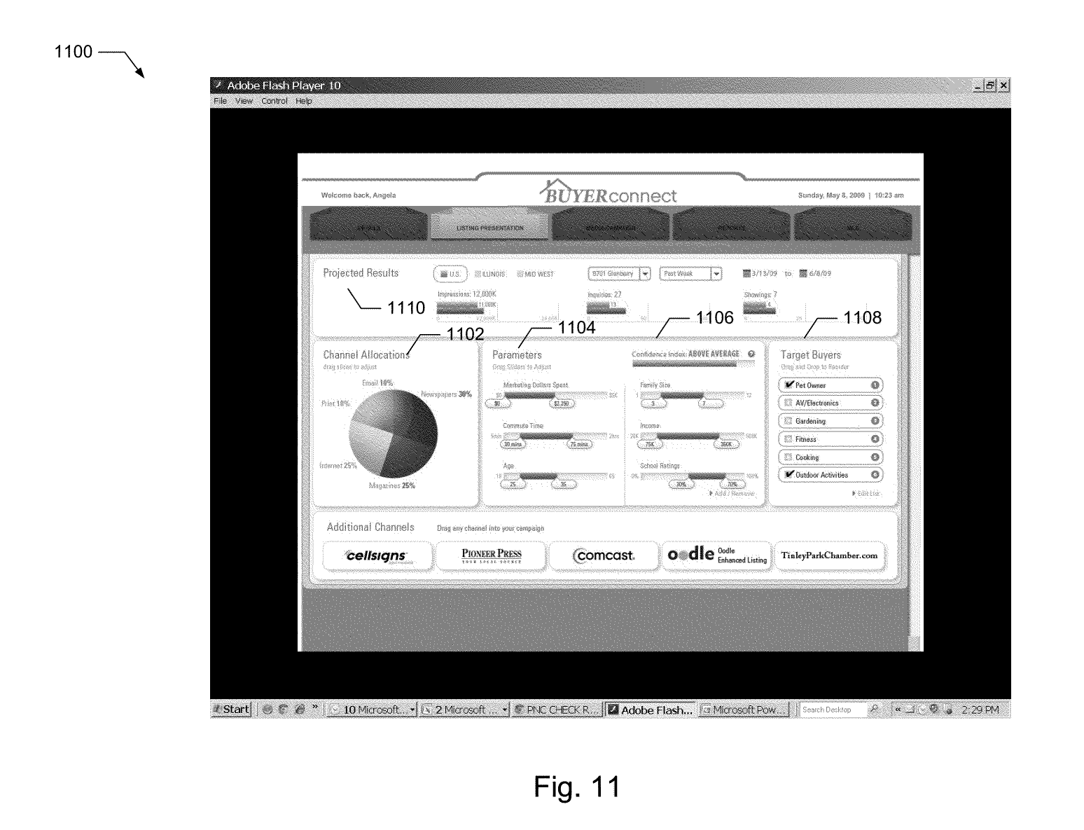

FIGS. 6 to 15 illustrate example screen shots of generating an ideal buyer profile for a real estate listing and generating a marketing campaign to sell the real estate listing according to an example embodiment of the disclosed correlation and marketing system.

FIG. 6 is an example screen shot of a user entering in a property address for a real estate listing 602. Based upon the entered real estate listing, the correlation and marketing system may analyze and review existing information in the knowledge database to develop a profile for an ideal buyer of the property.

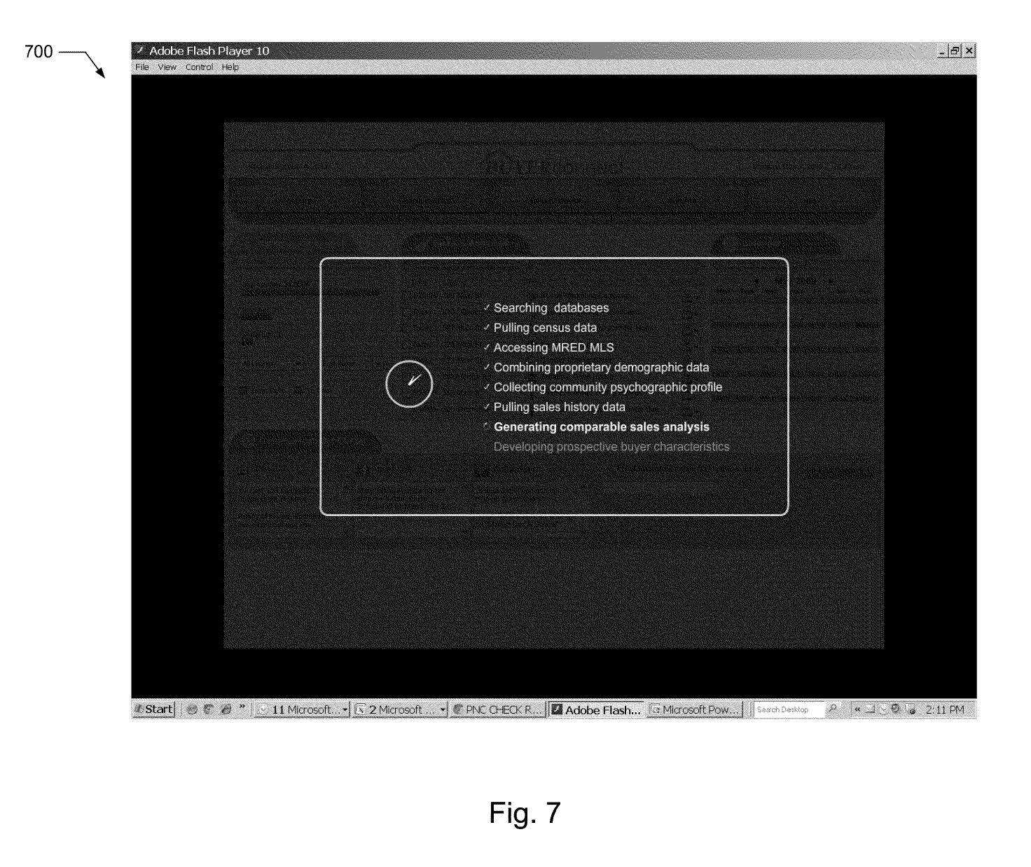

FIG. 7 shows an example screen shot of the correlation and marketing system searching databases, pulling census data, accessing MRED MLS, combining proprietary demographic data, collecting community psychographic profiles, pulling sales history data and generating comparable sales analysis to develop prospective buyer characteristics.

In one embodiment, the correlation and marketing system generates a profile for the real estate listing for the entered property. The profile not only includes information about the home and other traditional real estate information, but it also includes demographic and life style information for the geographical area. In one embodiment, the user, who may be an agent or a home owner, can add or update information about the listing using screenshot 800.

The correlation and marketing system then correlates attributes from the knowledge database and searches through all of the buyer characteristics stored in the knowledge database to create an ideal or optimized buyer profile. The ideal buyer profile may include information such as where that ideal buyer may currently live, the demographics of the ideal buyer, the family size, age and income of the ideal buyer, and the psychographic profile including activities and analytics for the ideal buyer. The ideal buyer profile may also include behavioral information such as the types of attractions that the ideal buyer is interested in, what features the ideal buyer is looking for, as well as specific timing information about the buying life cycle in which the ideal buyer may be. For example, the ideal buyer for a property may be a buyer who is just beginning the home searching process or, alternatively, the correlation and marketing system may determine that an ideal buyer for a property has been looking for a property for six months.

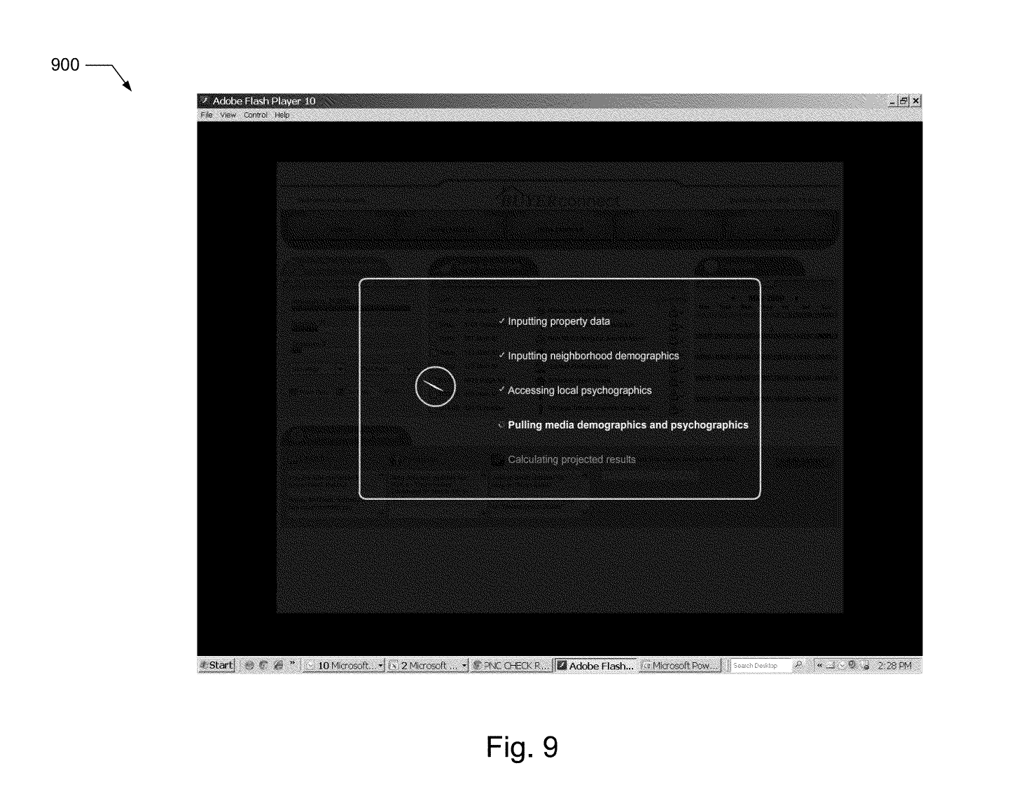

As shown in screenshot 900 in FIG. 9, the correlation and marketing system uses the buyer profile as well as information about the real estate listing and correlates that information with a media or messaging knowledge base to determine the most effective media and messages for finding an ideal buyer for that real estate listing. For example, as shown in screenshot 900, the correlation and marketing system inputs property data, inputs neighborhood demographics, accesses local psychographics and pulls media demographics and psychographics and calculates projected results. In one embodiment, the correlation and marketing system may match an existing buyer to an ideal property.

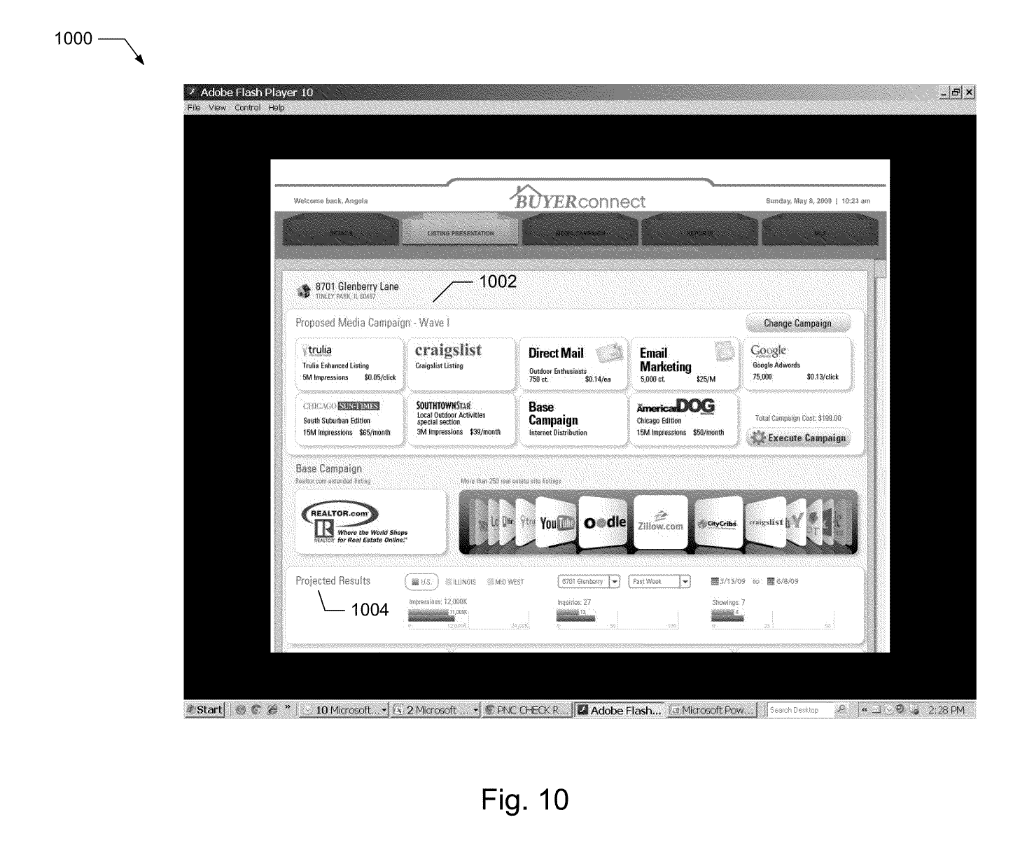

As illustrated in FIG. 10, the correlation and marketing system may then display a proposed media campaign to attract an ideal buyer for the real estate listing. The marketing plan may consist of specific media, messages, etc. The marketing plan may also provide projected results. All of the various components of the marketing plan may be adjusted based upon a budget amount. For example, the user may be able to modify a budget amount to create a more effective or a more widespread marketing plan in order to more quickly sell a real estate property to an ideal buyer.

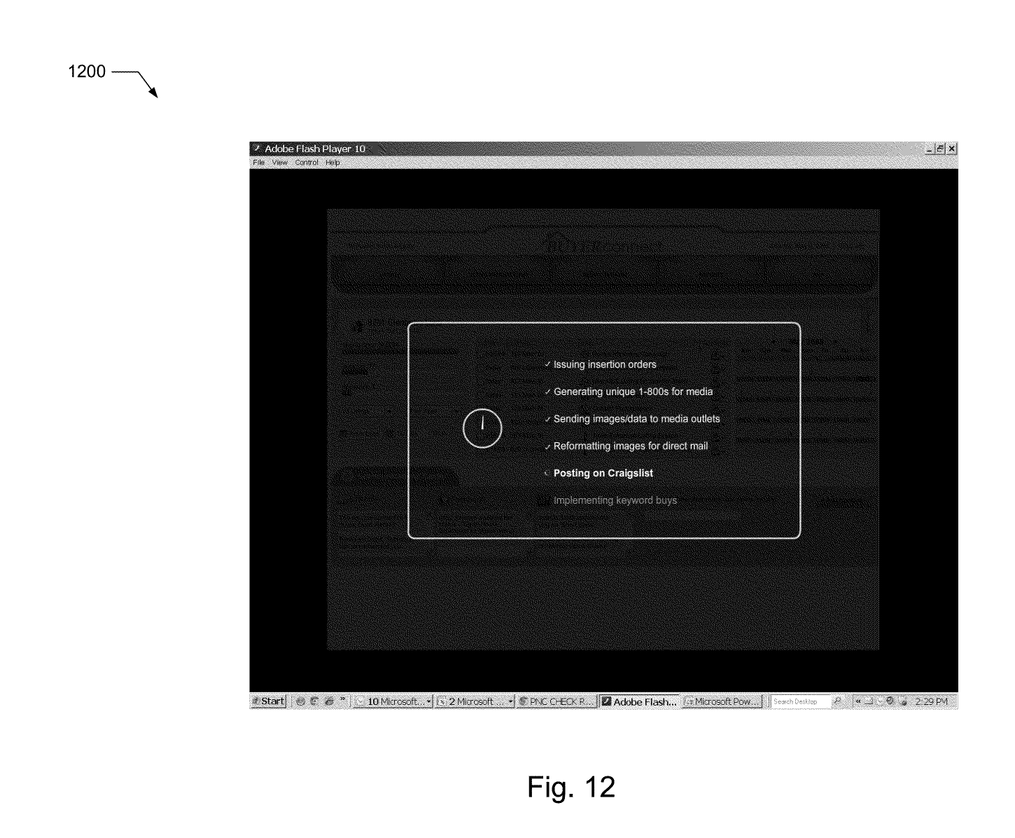

In one embodiment, the correlation and marketing system also allows for a user to change or modify certain parameters. For example, a user may have specific expertise with a housing market or may have certain preferences. The correlation and marketing system allows the user to modify the marketing plan including modifying channel allocations 1102, parameters such as marketing dollars spent, commute time and age 1104, a family-size, income level and school ratings, and confidence index 1106, and target buyers 1108. For example, the user may want to target pet owners and potential buyers who love outdoor activities as shown in screenshot 1100. Based upon the modifications made by the user, the correlation and marketing system can generate an entire marketing campaign tailored to sell the real estate property. In one embodiment, once the user has completed specifying details about the campaign, the correlation and marketing system begins to issue insertion orders, generate unique 1-800 numbers to place in media outlets, send images and data to media outlets, reformat images for direct mail, post on selected websites such as Craigslist, and implement keyword buys as illustrated in screenshot 1200 of FIG. 12.

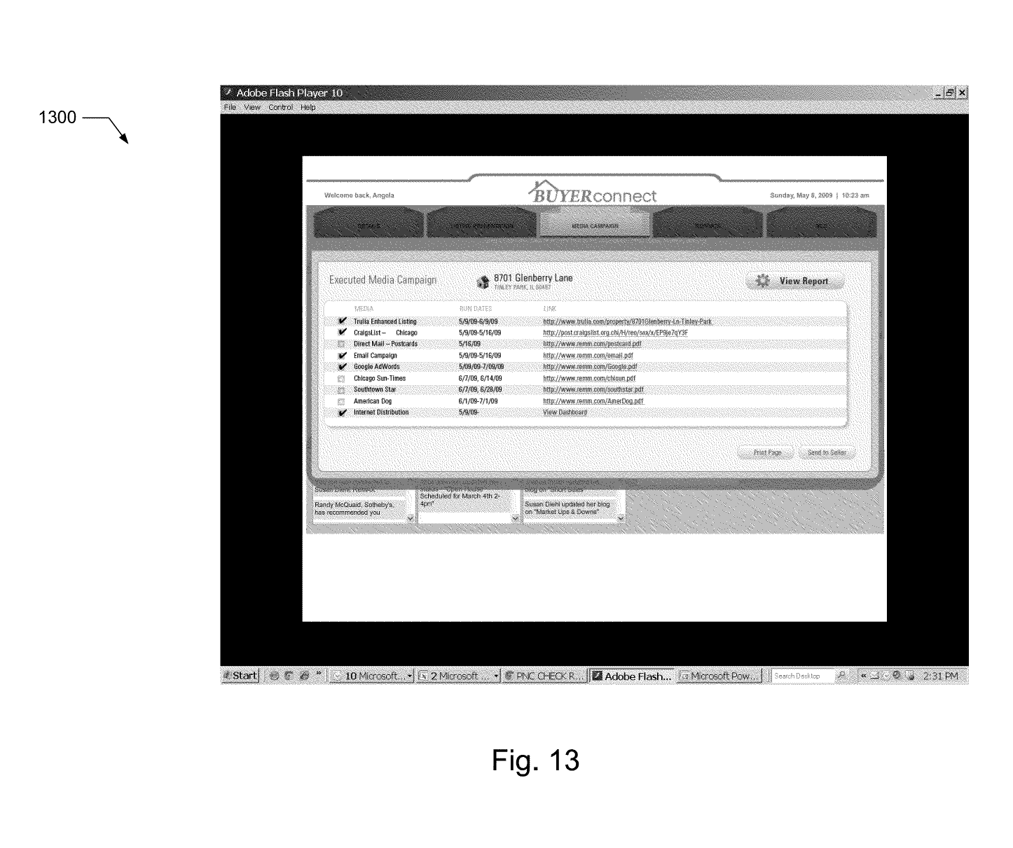

As shown in FIG. 13, the correlation and marketing system then displays a confirmation screenshot 1300 of the executed marketing plans. In one embodiment, the correlation and marketing system can also track and report results from an executed marketing campaign.

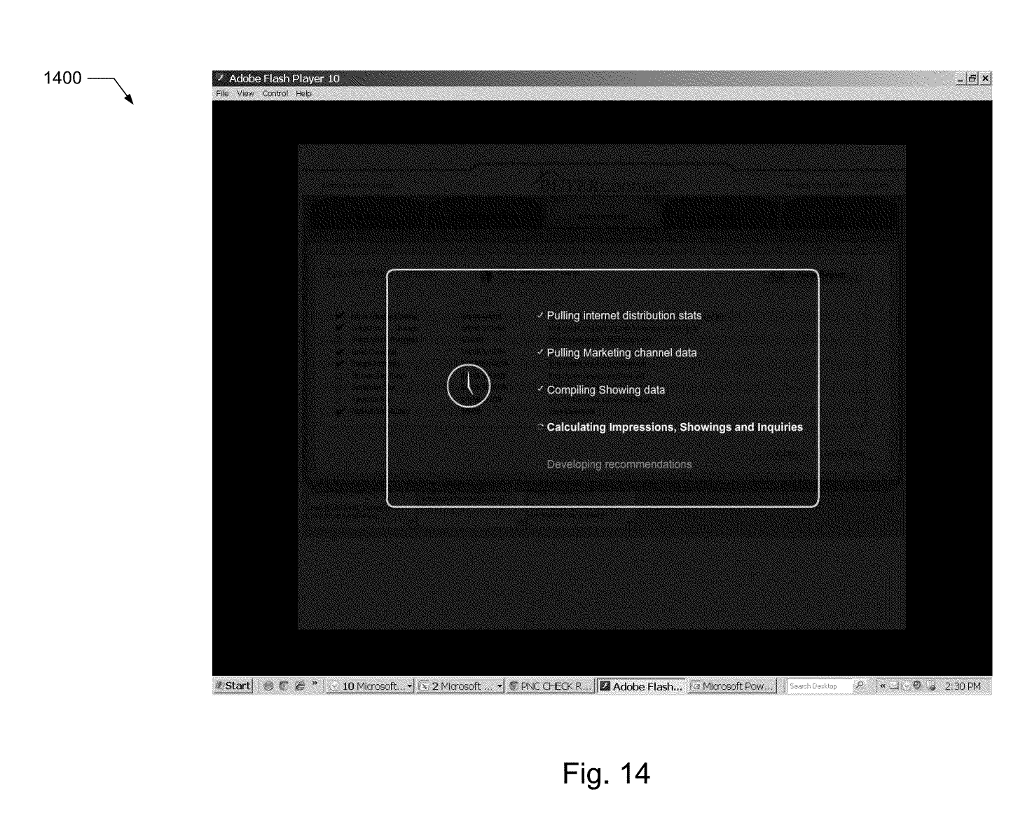

FIG. 14 illustrates screenshot 1400 showing that the correlation and marketing system can pull internet distribution statistics, pull marketing channel data, compile data about showings, calculate impressions, showings and inquiries, and develop recommendations. The correlation and marketing system can then display results of a marketing campaign.

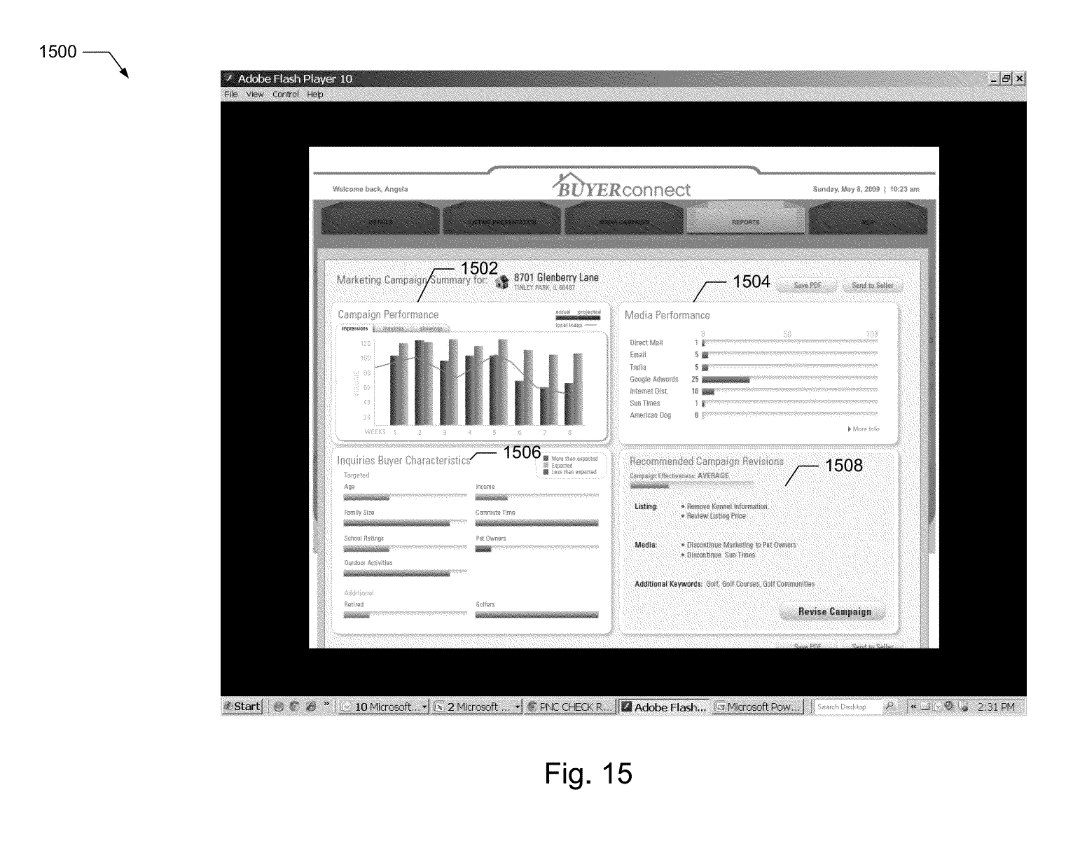

The correlation and marketing system allows a user to further modify and tweak an ongoing campaign as shown in screenshot 1500 of FIG. 15. As shown in FIG. 15, the user is presented with information about a campaign performance 1502, a media performance 1504, inquiries buyer characteristics 1506 and recommended campaign revisions 1508. For example, the correlation and marketing system may know from previous experience how a campaign should be modified in order to make the campaign more effective. As shown in item 1508 of FIG. 15, the correlation and marketing system ranks the effectiveness of the campaign and provides recommendations to listings and media and additional keywords in order to revise a campaign.

In one embodiment, the marketing campaign is matched to buyers already existing in the knowledge database. In one embodiment, the marketing campaign is used to find new buyers outside of the knowledge database.

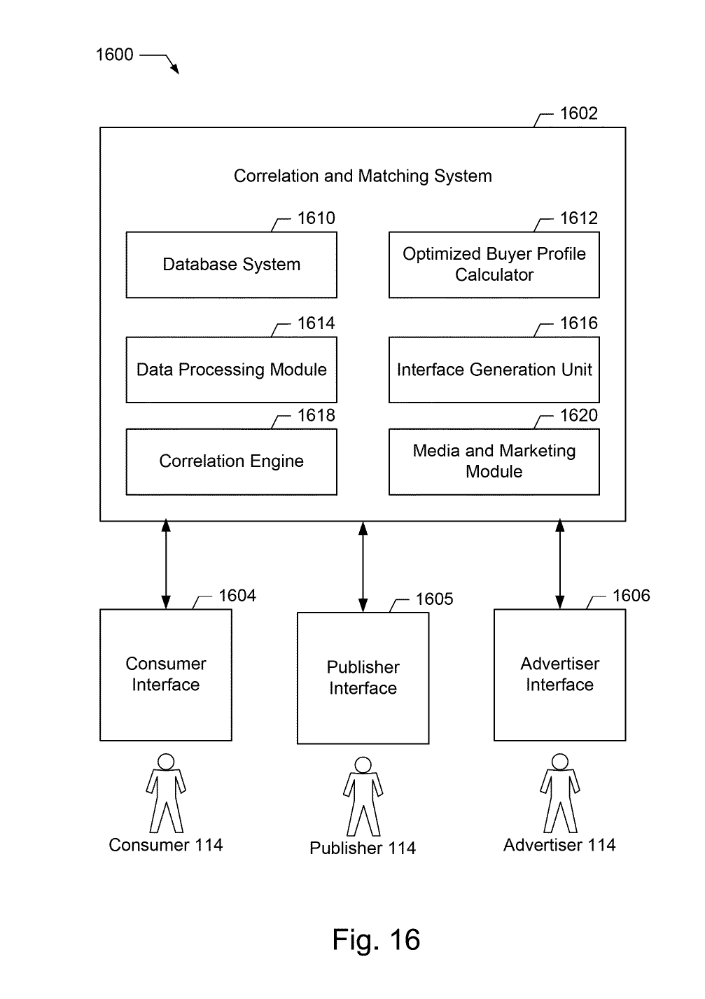

FIG. 16 is a block diagram showing an example correlation and marketing structure 1600 which includes a correlation and marketing system 1602, a consumer interface 1604, a publisher interface 1605, and an advertiser interface 1606. The example correlation and marketing system 1602 may be implemented on one or more host devices 104 accessing one or more servers 108, 226. In an example embodiment, the correlation and marketing system 1602 includes a database system 1610, an optimized buyer profile calculator 1612, a data processing module 1614, an interface generation unit 1616, a correlation engine 1618 and a media and marketing module 1620.

A user 114 may be, for example, a consumer—who may be a buyer or a seller—that interacts with the consumer interface 1604. A database system 1610 may include a wide variety of data about real estate transactions and attributes.

An optimized buyer profile calculator 1612 may provide information about an optimized buyer profile for a specific real estate property. A data processing module 1614 may be used to analyze, parse, and process the wide variety of data available to the correlation and marketing system.

Interface generation unit 1616 may provide, for example, HTML files that are used at the consumer interface 1604, publisher interface 1605, and advertiser interface 1606 to provide information to the users 114. It should be appreciated that consumer interface 1604, publisher interface 1605, and advertiser interface 1606 may be considered to be part of the correlation and marketing system 1602, however, for discussion purposes, the consumer interface 1604, publisher interface 1605, and advertiser interface 1606 may be referred to as separate from the correlation and marketing system 1602.

For example, a user 114 may interact with a consumer interface 1604 to research and review real estate properties. Or, a user 114 may interact with an advertiser interface 1606 to advertise properties, merchandise, and services.

In one example embodiment, the correlation and marketing structure 1600 may include a publisher interface 1605 for publishers to input and review information about publishing within the correlation and marketing system or reaching other users 114 via publishing.

The optimized buyer profile calculator 1612 may process data sent by the consumer interface 1604 and the advertiser interface 1606. The optimized buyer profile calculator 1612 may also rely on data from database system 1610. The optimized buyer profile calculator 1612 may also process information collected by the data processing module 1614 and the correlation engine 1618 to prepare an optimized buyer profile for a property, described in further detail below.

The media and marketing module 1620 may use the data collected from consumer interface 1604 and advertiser interface 1606 and in the knowledge database to recommend marketing activities and generate and execute marketing campaigns.

It should be appreciated that the consumer interface 1604 and the advertiser interface 1606 may look similar and have similar functionality, but have some portions that look different and behave differently for employees and employers. The consumer interface 1604, publisher interface 1605, and advertiser interface 1606 may also provide options for purchasing memberships or registering with an ID and a password. Registered users may have more access to information and more functions available than non-registered users. In one example embodiment, one integrated interface may provide access to consumer interface 1604, publisher interface 1605, and advertiser interface 1606. For example, a service provider that provides optimized buyer profiles and targeted marketing campaigns may own a website that includes consumer interface 1604, publisher interface 1605, and advertiser interface 1606.

Accordingly, consumer interface 1604, publisher interface 1605, and advertiser interface 1606 may provide a wide range of information, for example, based on any searches or queries performed by a user 114.

It should be appreciated that certain functions described as performed, for example, at correlation and marketing system 1602, may instead be performed locally at consumer interface 1604, publisher interface 1605, and advertiser interface 1606. It should be appreciated that the consumer interface 1604, publisher interface 1605, and advertiser interface 1606 may be implemented, for example, in a web browser using an HTML file received from the correlation and marketing system 1602. In an example embodiment, consumer interface 1604, publisher interface 1605, and advertiser interface 1606 may be located on a website, and may further be implemented as a secure website. Employees and employers may view match results on secure web pages, requiring a login ID and a password, that can only be accessed by authorized users. Also, consumer interface 1604, publisher interface 1605, and advertiser interface 1606 may require a local application, for example, which a use may pay for to have access to, for example, information from the correlation and marketing system 1602 such as results output by the optimized buyer profile calculator 1612.

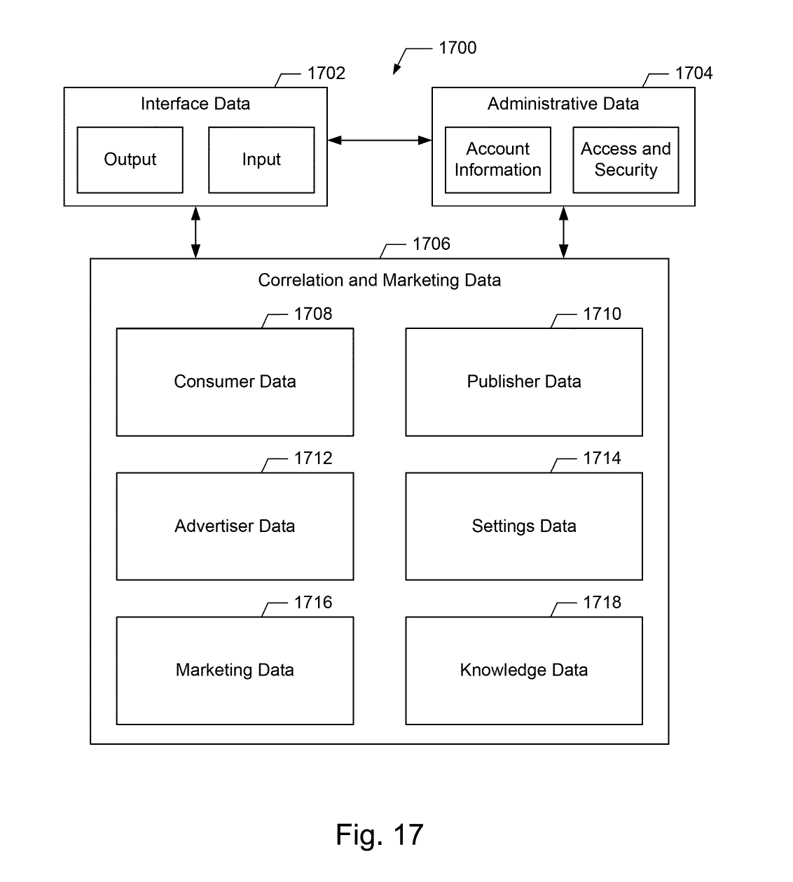

FIG. 17 illustrates a block diagram of an example data architecture 1700. In the example data architecture 1700, interface data 1702, administrative data 1704, and correlation and marketing data 1706 interact with each other, for example, based on user commands or requests. The interface data 1702, administrative data 1704, and correlation and marketing data 1706 may be stored on any suitable storage medium (e.g., server 226). It should be appreciated that different types of data may use different data formats, storage mechanisms, etc. Further, various applications may be associated with processing interface data 1702, administrative data 1704, and correlation and marketing data 1706. Various other or different types of data may be included in the example data architecture 1700.

Interface data 1702 may include input and output data of various kinds. For example, input data may include mouse click data, scrolling data, hover data, keyboard data, touch screen data, voice recognition data, etc., while output data may include image data, text data, video data, audio data, etc. Interface data 1702 may include formatting, user interface options, links or access to other websites or applications, and the like. Interface data 1702 may include applications used to provide or monitor interface activities and handle input and output data.

Administrative data 1704 may include data and applications regarding account information and access and security. For example, administrative data 1704 may include information used for as creating or modifying consumer accounts or publisher accounts. Further, administrative data 1704 may include access data and/or security data. Administrative data 1704 may interact with interface data 1702 in various manners, providing a user interface 1604, 1605, 1606 with administrative features, such as implementing a user login, password, and the like.

Correlation and marketing data 1706 may include, for example, consumer data 1708, publisher data 1710, advertiser data 1712, settings data 1714, marketing data 1716, and/or knowledge data 1718. Consumer data 1708 may include information about potential or actual buyers, such as name, age, education, work experiences, etc. Publisher data 1710 may include information about potential publishers, such as name, industry, print magazines, etc. Advertiser data 1712 may include information about advertisers, such as name, location, affiliations, brand strategy, etc. Settings data 1714 may include information about the settings for a correlation and marketing system, such as correlation matrix information, attributes being correlated, etc. Marketing data 1716 may include information about media, messages and marketing campaigns generated by the correlation and marketing system. Knowledge data 1718 may include information about various attributes, correlations, information about real estate listings, geographic data, etc.

It should be appreciated that data may fall under multiple categories of correlation and marketing data 1706, or change with the passage of time or circumstance. It should also be appreciated that correlation and marketing data 1706 may be tailored for a group of users, for example, if a new user joins the correlation and marketing system as a consumer, the publisher data 1710, advertiser data 1712, settings data 1714, marketing data 1716, and knowledge data 1718 may change.

The integration of the various types of correlation and marketing data 1706 received from the consumer interface 1604, publisher interface 1605, and advertiser interface 1606 may provide a synergistic and optimal resource for consumers, publishers and advertisers alike. In an example embodiment, a home owner looking to sell her home may benefit greatly from using an application in a mobile device 103 to receive both information about an “ideal” buyer for her home and also to check on the status of a marketing campaign geared towards calculating and locating a buyer for her home, in real-time, based upon registering with and subscribing to a service website implementing the correlation and marketing system.

Correlation and marketing data 1706 may be maintained in various servers 108, in databases or other files. It should be appreciated that, for example, a host device 104 may manipulate correlation and marketing data 1706 in accordance with the administrative data 1704 and interface data 1702 to provide requests or reports to users 114 including consumers, publishers and advertisers, and perform other associated tasks.

In summary, persons of ordinary skill in the art will readily appreciate that methods and apparatus for matching a real estate listing to a consumer profile and creating a marketing campaign based on the consumer profile have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of selling real estate comprising:
processing a plurality of real estate transactions including sales of real estate properties to buyers of the real estate properties, the real estate properties having first real estate attributes and the buyers having first buyer attributes;
generating correlations between the first real estate attributes and the first buyer attributes;
generating a knowledge database storing the processed real estate transactions, the first real estate attributes, and the first buyer attributes;
receiving a real estate listing for a target real estate property, the target real estate property having second real estate attributes, the real estate listing including the second real estate attributes;
determining an optimized buyer profile based upon the knowledge database and the real estate listing; and
generating recommended marketing activities based upon the optimized buyer profile.

2. The method of claim 1, further comprising executing a marketing campaign based upon the recommended marketing activities.

3. The method of claim 1, further comprising: conditioned upon a sale of the target real estate property to a new buyer, the new buyer having second buyer attributes, modifying the knowledge database based upon the second real estate attributes and the second buyer attributes.

4. The method of claim 2, wherein the new buyer learns of the target real estate property as a result of the marketing campaign.

5. The method of claim 1, wherein the real estate transactions include potential sales and failed real estate transactions.

6. The method of claim 1, wherein the buyers include actual buyers and potential buyers.

7. The method of claim 1, wherein the first and second real estate attributes each includes at least three of (a) a number of bedrooms, (b) a number of bathrooms, (c) a price, (d) a home size, (e) a tax amount, (f) a lot size, (g) a parking size, (h) a basement indicator, and (i) an age.

8. The method of claim 1, wherein the first and second buyer attributes each includes at least three of (a) family size, (b) credit score, (c) pet indicator, (d) work address, (e) religion, (f) profession, (g) income, (h) and (i) health consciousness.

9. The method of claim 1, wherein the recommended marketing activities include media selected based upon the optimized buyer profile.

10. The method of claim 1, wherein executing the marketing campaign includes placing an advertisement.

11. The method of claim 10, wherein the advertisement is selected based upon the optimized buyer profile.

12. The method of claim 1, wherein the marketing activities include at least one of marketing tactics, marketing strategies, and search results.

13. An apparatus for matching a real estate listing to a buyer profile and creating a marketing campaign based on the buyer profile, the apparatus comprising:
a processor;
an input device operatively coupled to the processor and a network; and
a memory device operatively coupled to the processor, the memory device storing a software application, the software application:
processing a plurality of real estate transactions including sales of real estate properties to buyers of the real estate properties, the real estate properties having first real estate attributes and the buyers having first buyer attributes;
generating correlations between the first real estate attributes and the first buyer attributes;
generating a knowledge database storing the processed real estate transactions, the first real estate attributes, and the first buyer attributes;
receiving a real estate listing for a target real estate property, the target real estate property having second real estate attributes, the real estate listing including the second real estate attributes;
determining an optimized buyer profile based upon the knowledge database and the real estate listing; and
generating recommended marketing activities based upon the optimized buyer profile.

14. A non-transitory computer readable medium storing software instructions which, when executed, cause an information processing apparatus to:
process a plurality of real estate transactions including sales of real estate properties to buyers of the real estate properties, the real estate properties having first real estate attributes and the buyers having first buyer attributes;
generate correlations between the first real estate attributes and the first buyer attributes;
generate a knowledge database storing the processed real estate transactions, the first real estate attributes, and the first buyer attributes;
receive a real estate listing for a target real estate property, the target real estate property having second real estate attributes, the real estate listing including the second real estate attributes;
determine an optimized buyer profile based upon the knowledge database and the real estate listing; and
generate recommended marketing activities based upon the optimized buyer profile.
